(19) United States
(12) Patent Application Publication
(10) Pub. No.: US 2018/0115127 A1
(43) Pub. Date: Apr. 26, 2018

(54) LOW-PROFILE MECHANICAL ELECTRICAL INTERCONNECT

(71) Applicant: Bell Helicopter Textron Inc., Fort Worth, TX (US)

(72) Inventors: Jared M. Paulson, Fort Worth, TX (US); Robert A. Self, Fort Worth, TX (US)

(73) Assignee: Bell Helicopter Textron Inc., Fort Worth, TX (US)

(21) Appl. No.: 15/299,696

(22) Filed: Oct. 21, 2016

(51) Int. Cl. H01R 31/00; H01R 43/20; B64D 15/12

(52) U.S. Cl. CPC H01R 31/00; B64D 15/12; H01R 43/20

(57) ABSTRACT

An electrical interconnect including an electrically conductive male interlock having a substantially flat base portion and a longitudinally extending locking member, and an electrically conductive female interlock having a first retention groove in a support member, the first retention groove for receiving and retaining the locking member on the support member. At least a portion of the locking member is disposed on a surface of the female interlock and slidably received in the first retention groove to form a first locked position so as to enable electrical conduction.

### BACKGROUND

### Technical Field

The present disclosure relates to an electrical interconnect, and more particularly, to a low-profile electrical interconnect using mechanical attachment.

### Description of Related Art

Electrical connections are used in many industries and products worldwide and are needed in space-constrained locations. For example, an aircraft wing or rotor blade ice protection system. Ice can accumulate on the surfaces of aircraft during flight in icing conditions and can negatively affect the performance of the aircraft. At times, aircraft structures are exposed to high strain environments and they demand ice protection solutions that function properly in all flight conditions. Incumbent ice protection solutions often experience unacceptable failures at soldered electrical interconnect locations. Solder joints are common in use for electrical interconnections because they are effective methods of fusing two items together to complete an electrical circuit. However, failures can occur when the structures are exposed to high-strain environments and/or solder joints are of poor quality. When an ice protection solution is required on the surface of or within the construction of an aircraft component that is exposed to the airstream, it is desired for the electrical circuit and accompanying features to be as low profile as possible in order to fit within the minimal construction space allotted and not to negatively impact the aircraft performance.

Solder joints offer a lower profile than more robust mechanical electrical interconnections. A solder joint is the fusing of two or more metal surfaces by melting an alloy at the interface. Solder joints perform their function well in stationary or strain-free environments. In general, solder joint failures remain one of the primary causes of equipment failure, particularly when subjected to motion or elevated-strain environments. Soldering is an operator dependent process that requires a high-standard of workmanship in order to produce a high quality result. Unfortunately, poor quality of solder joints and extreme environments can often result in unreliable electrical interconnections. In extreme flight conditions, a more reliable solution is required.

There is a need for an improved low-profile mechanical electrical interconnection that completes an electrical circuit in a spaced-constrained location.

### SUMMARY

In a first aspect, there is provided an electrical interconnect including an electrically conductive male interlock having a substantially flat base portion and a longitudinally extending locking member, and an electrically conductive female interlock having a first retention groove in a support member, the first retention groove for receiving and retaining the locking member on the support member. At least a portion of the locking member is disposed on a surface of the female interlock and slidably received in the first retention groove to form a first locked position so as to enable electrical conduction.

In an exemplary embodiment, the locking member has sufficient flexibility to accommodate bending to the first locked position.

In yet another embodiment, the longitudinally extending locking member has a laterally projecting portion that extends beyond the first retention groove.

In still another embodiment, the laterally projecting portion has sections adapted to be deflected in an inward direction to secure into the first locked position.

In another embodiment, the locking member is surrounded by the base portion of the male interlock in an unlocked position.

In one embodiment, the laterally projecting portion is generally a triangular, semi-circular, or rectangular shape.

In another embodiment, the laterally projecting portion is a pair of tabs on the sides of locking member.

In yet another embodiment, the locking member extends beyond the base portion of the male interlock.

In an exemplary embodiment, the first retention groove has a first channel portion extending along a longitudinal axis in the support member and a second channel portion extending transverse to the channel axis being dimensioned to permit insertion of the locking member therethrough.

In still another embodiment, the first channel portion has an angle of about zero to about 90 degrees relative to the longitudinal axis of the support member.

In another embodiment, the locking member does not extend beyond the first channel portion.

In one example, a second retention groove generally parallel to the second channel portion is disposed in the support member, the second retention groove being dimensioned to permit insertion of the locking member therethrough.

In an exemplary embodiment, the locking member extends beyond the first channel portion and at least a portion of the locking member is received in the second retention groove to form a second locked position; in the second locked position at least a portion of the locking member is positioned under the female interlock.

In still another example, a sleeve is provided which encompasses at least a portion of the male interlock and the female interlock when in the first locked position.

In a second aspect, there is a composite assembly, including an outer surface member, an inner surface member, and an electrical interconnect sandwiched between the outer surface member and inner surface member and disposed on the inner surface.

In an example, the outer surface member is a heating zone.

In a third aspect, there is a method of constructing a composite assembly, including providing an outer surface member, providing an inner surface member, and positioning an electrical interconnect on the inner surface.

In example, the method of constructing a composite includes curing at least one of the outer surface member and the inner surface member so as to impart compressive force against the electrical interconnect.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF THE DRAWINGS

The novel features believed characteristic of the embodiments of the present disclosure are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a tiltrotor aircraft, according to one example embodiment;

FIG. 2A is a schematic top view of a tiltrotor blade in FIG. 1, according to one example embodiment;

FIG. 2B is schematic cross-sectional view of a mechanical electrical interconnect between two rotor blade surfaces, according to one example embodiment;

FIG. 3 is a top view of a mechanical electrical interconnect in a disconnected position, according to one example embodiment;

FIG. 4 is a top perspective view of the mechanical electrical interconnect in FIG. 3 in a connected position, according to one example embodiment;

FIG. 5 is a bottom perspective view of the mechanical electrical interconnect in FIG. 3 in a connected position, according to one example embodiment;

FIG. 6 is a top view of a mechanical electrical interconnect in a disconnected position, according to one example embodiment;

FIG. 7 is a top perspective view of the mechanical electrical interconnect in FIG. 6 in a connected position, according to one example embodiment;

FIG. 8 is a bottom perspective view of the mechanical electrical interconnect in FIG. 6 in a connected position, according to one example embodiment;

FIG. 9 is a top view of a mechanical electrical interconnect in a disconnected position, according to one example embodiment;

FIG. 10 is a top perspective view of the mechanical electrical interconnect in FIG. 9 in a connected position, according to one example embodiment;

FIG. 11 is a bottom perspective view of the mechanical electrical interconnect in FIG. 9 in a connected position, according to one example embodiment;

FIG. 12 is a top view of a mechanical electrical interconnect including a sleeve, according to one example embodiment; and

FIG. 13 is a top perspective view of the mechanical electrical interconnect in FIG. 10 in a connected position with a sleeve, according to one example embodiment.

### DESCRIPTION OF THE PREFERRED EMBODIMENT

Illustrative embodiments of the apparatus and method are described below. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The embodiments of the mechanical electrical interconnect will be described with reference to a blade on a tiltrotor aircraft 100, it will be appreciated that the mechanical electrical interconnect may be used on any type of aircraft or device in which it is desirable to have electrically powered components in space constrained locations; for example, and not limitation, the mechanical interconnects can be included in the wing, blade, fuselage, and landing gear for a rotorcraft, in the unmanned and manned configurations. In some embodiments, the mechanical electrical interconnect is used in ice protection systems, tip lights, control surfaces, and other electrically powered components.

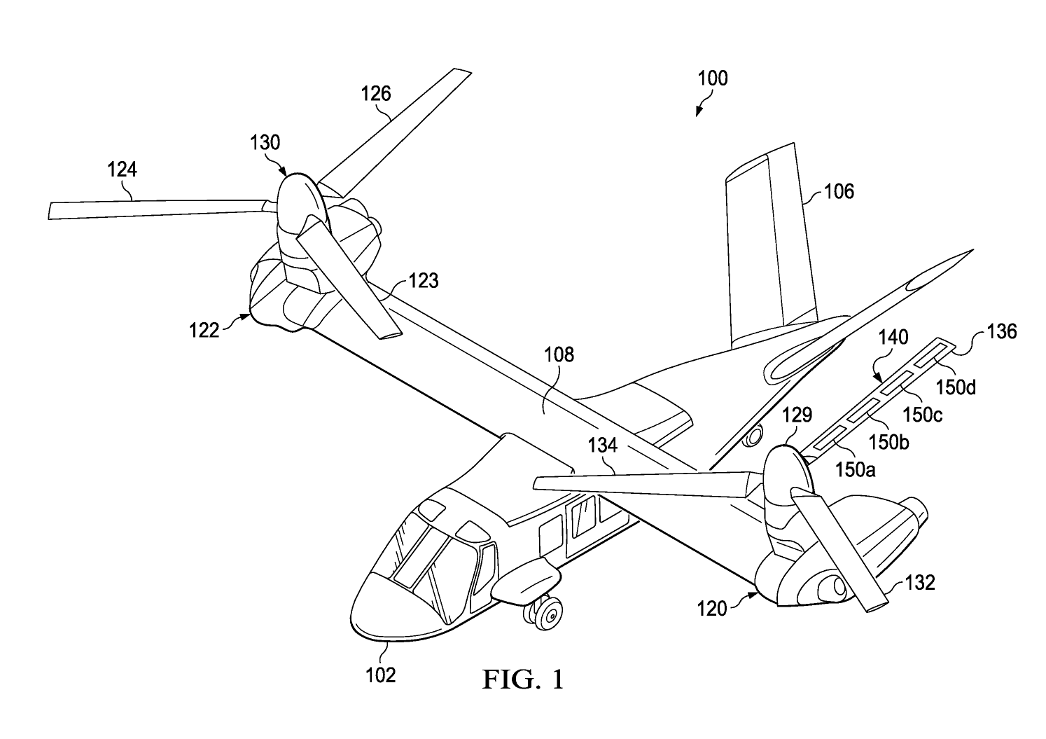

Referring to FIG. 1, a tiltrotor aircraft 100 is illustrated including a fuselage 102, a landing gear 104, a tail member 106, a wing 108, a propulsion system 120, and a propulsion system 122. Each propulsion system 120 and 122 includes a gearbox, an engine, a power source, and a rotatable rotor system 128 and 130, respectively. The position of the rotor systems 128 and 130 can be selectively controlled in order to selectively control direction, thrust, and lift of the tiltrotor aircraft 100. The tiltrotor aircraft 100 can be operated in helicopter mode, in which nacelles are positioned substantially vertical to provide a lifting thrust, as shown in FIG. 1. The tiltrotor aircraft 100 can also be operated in an airplane mode, in which rotor systems 128 and 130 are positioned substantially horizontal such that the rotor systems 128 and 130 provide a forward thrust in which a lifting force is supplied by the wing 108, respectively. It should be appreciated that the tiltrotor aircraft 100 can be operated such that rotor systems 128 and 130 are selectively positioned between airplane mode and helicopter mode, which can be referred to as a conversion mode.

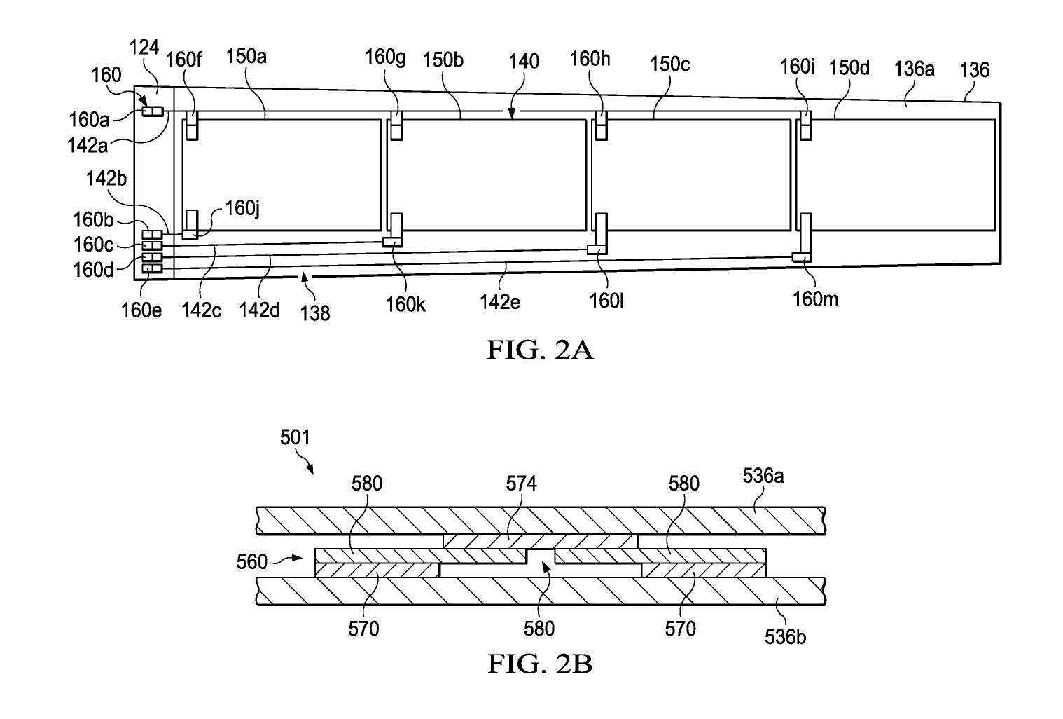

Each rotatable rotor system 128 and 130 has a plurality of rotor blades 132, 134, and 136; 123, 124, and 126, respectively, associated therewith. The blade 136 in FIGS. 1 and 2 is representative of the rotor blades 132, 134, 123, 124, and 126; therefore, for sake of efficiency certain features will be disclosed only with regard to the rotor blade 136. However, one of ordinary skill in the art would fully appreciate an understanding of the rotor blades 132, 134, 123, 124, 126 based on the disclosure herein of the rotor blade 136. In an embodiment, the main rotor blade 136 has an airfoil contour with a root end at the hub 129 and an outboard tip end. Although embodiments are described herein in terms of an example of a main rotor blade, other rotor blades such as tail rotors or turbine blades may also benefit from the electrical interconnects described herein.

FIG. 2 shows a schematic representation of an electrical power system 138 that provides an electrically conductive path to power to an ice protection system 140 on the rotor blade 136. In other embodiments, the electrical power system 138 provides power to control surfaces, tip lights, and/or other electrically powered components.

The ice protection system 140 can be located on an outer surface member 136a or within the rotor blade 136 on an inner surface member 136b. The ice protection system 140 includes at least one heating zone 150. FIGS. 1 and 2 illustrate a first heating zone 150a, a second heating zone 150b, a third heating zone 150c, and a fourth heating zone 150d that are responsible for the heating an outer surface of the blade 136 to prevent or remove ice thereon. The number and placement of heating zones can be adjusted for a given ice protection system.

The electrical power system 138 includes a power source 124 schematically shown in FIG. 2A. The power source 124 is an electromechanical slip ring located within the mast at the center of the rotor system 128. The power source 124 includes a wire routed from the slip ring to the inboard ends of the rotor blade 136.

The power source 124 is electrically connected to at least one electrical interconnect 160 located in the root section of the blade 136. A plurality of electrical interconnects 160a, 160b, 160c, 160d, and 160e are electrically connected to a plurality of spanwise extending bus bars 142a, 142b, 142c, 142d, and 142e, respectively, as shown in FIG. 2A. Each of the bus bars 142a, 142b, 142c, 142d, and 142e can be a conductive metallic sheet, tape, or bar or combinations thereof. In one embodiment, A bus bar is made from a sheet of copper beryllium. The cross-sectional area of the bus bars 142a, 142b, 142c, 142d, and 142e are sufficient to allow for adequate electrical connection without excessive heat generation. In another embodiment, the bus bars are arranged sufficient to supply an electrical power source to an electrical device, for example, but not limitation, a bus bar can extend chordwise or at an angle from the longitudinal axis of the wing 108.

In one embodiment, a bus bar is located in either the leading or trailing edge of a rotor blade 136. The bus bar 142a is electrically connected to a plurality of electrical interconnects 160f, 160g, 160h, and 160i, which are generally located outboard of the root end and in the leading edge of the rotor blade 136. The bus bars 142b, 142c, 142d, and 142e are electrically connected to a plurality of electrical interconnects 160j, 160k, 1601, and 160m, which are generally located outboard of the root end and in the trailing edge of the rotor blade. In an embodiment, a male or female interlock of the electrical interconnect 160 is integrally formed with the bus bar 142a.

The first heating zone 150a is electrically connected to the electrical interconnects 160f and 160j. The second heating zone 150b is electrically connected to the electrical interconnects 160g and 160k. The third heating zone 150c is electrically connected to the electrical interconnects 160h and 160l. The fourth heating zone 150d located near the blade tip is electrically connected to the 160i and 160m. In an embodiment, a male or female interlock of the electrical interconnect 160 is integrally formed with the heating zone 150a.

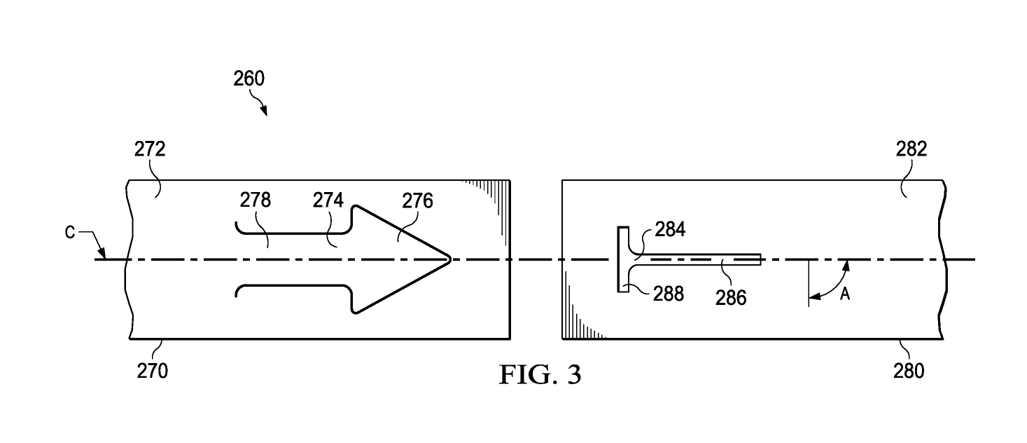

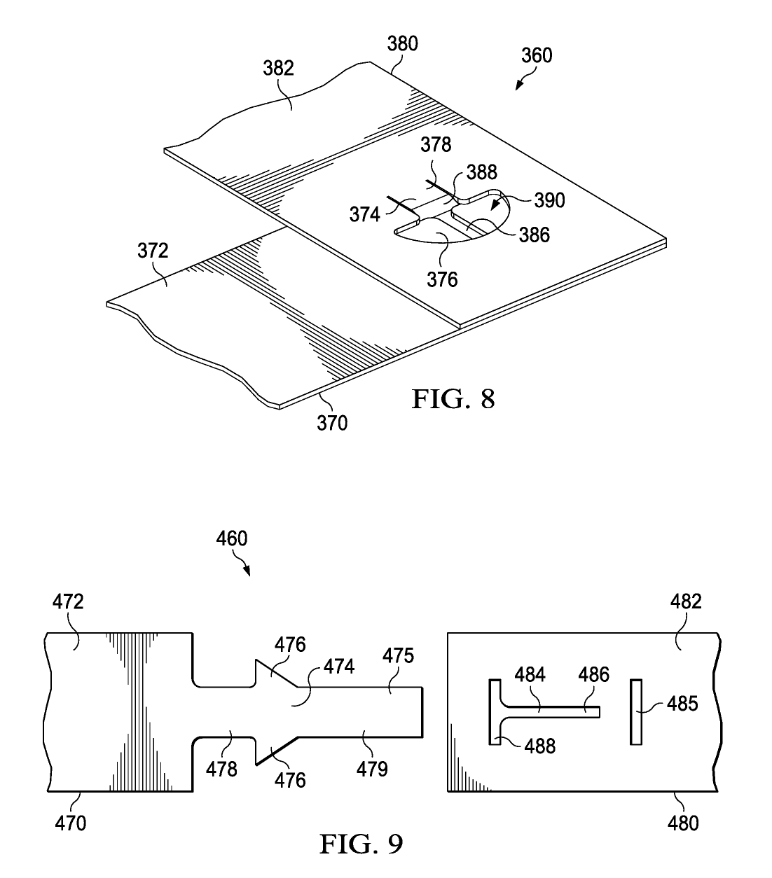

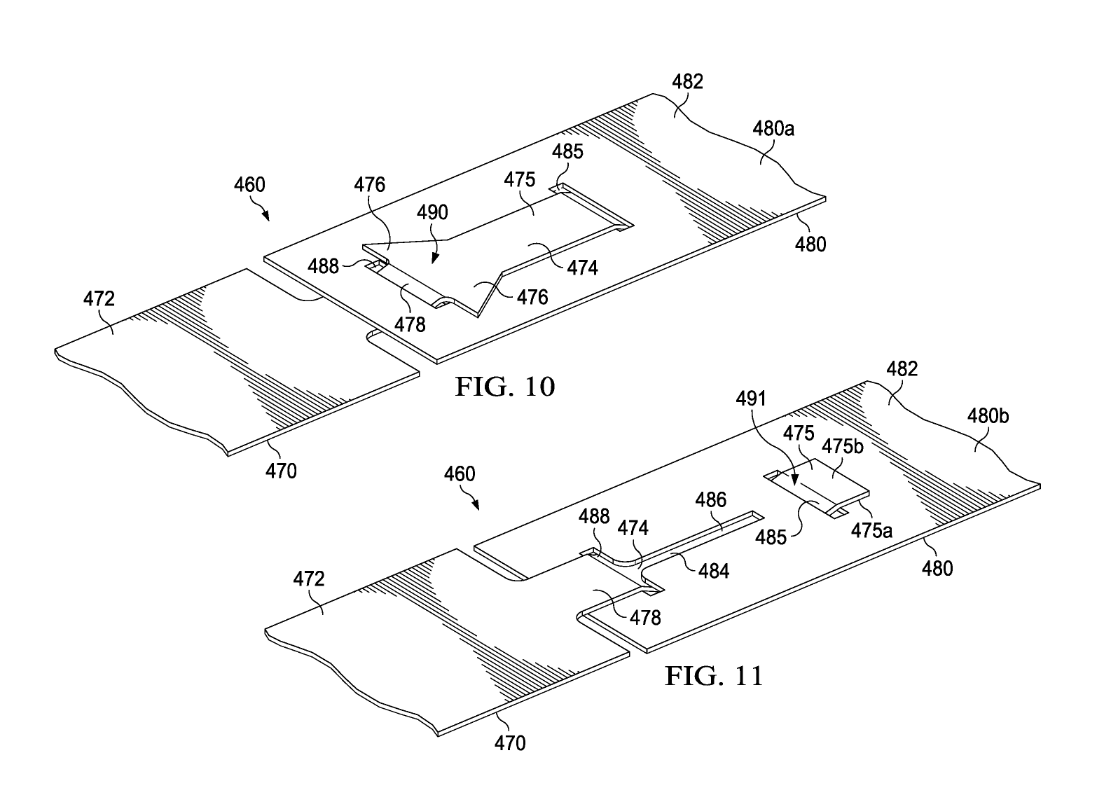

The electrical interconnect 160 can be selected from various embodiments as shown in FIGS. 3-13 and described herein. The electrical interconnect 160 can be located on a flexible member such as on an outer or inner surface of the rotor blade 136. The electrical interconnect 160 can withstand the strain levels caused by movement of the flexible member and remain in a locked and electrically conductive position. The electrical interconnect 160 is secured to a surface by an adhesive or resin layer that is sometimes laid up in a composite structure as shown in FIG. 2B. After the composite structure is cured, the electrical interconnect 160 is contained within the component and unable to come loose. In one embodiment, the electrical interconnect 160 is integral to a bus bar.

The electrical interconnect 260 shown in FIG. 3 is in an unlocked position and includes an electrically conductive flexible male interlock 270 having a substantially flat base portion 272 with a longitudinally extending locking member 274 located therein. In an embodiment, the locking member 274 is surrounded by the base portion 272. The locking member 274 has a sufficient flexibility to accommodate bending to a first locked position 290.

In one embodiment, the locking member 274 includes a first extended portion 278 that extends from the base portion 272 to a laterally projecting portion 276 that can be generally triangular in shape. The laterally projecting portion 276 is in a shape sufficient to secure the locking member 274 in a retention groove 284; for example, and not limitation, the lateral projecting portion 276 is generally triangular, semi-circular, rectangular, or trapezoidal in shape.

The electrical interconnect 260 also includes an electrically conductive female interlock 280 having a first retention groove 284 in a support member 282, the first retention groove 284 receives and retains the locking member 274 on a surface of the support member 282 in a first locked position 290.

The first retention groove 284 has a first channel portion 286 extending along the longitudinal axis C of the support member 282. A lateral end of the first channel portion 286 converges into a second channel portion 288 extending transverse to the first channel portion 286. In an exemplary embodiment, the first channel portion 286 extends parallel to the longitudinal axis C and is zero degrees from the longitudinal axis C. In another exemplary embodiment, the first channel portion 286 is disposed at a 90 degree angle relative to the longitudinal axis C of the female interlock 280, as shown in FIG. 7. It is noted, however, that any other angle may be employed (depending on the requirements of the electrical connections) without deviating from the scope of the invention. In one embodiment, the angle A of the first channel portion 286 relative to the longitudinal axis C ranges from about zero to about 90 degrees. However, as would be understood by those skilled in the art, the angle A may be varied to achieve an interlocking of the male interlock 270 and female interlock 280 sufficient to conduct electricity.

The second channel portion 288 has a sufficient width for receiving at least a portion of the locking member 274 therethrough. In one embodiment, the second channel portion has a sufficient width for receiving the first extended portion 278 of the male interlock 270 therethrough. The first channel portion 286 has a sufficient length for receiving at least a portion of the locking member 274 therethrough. In one embodiment, the first channel portion 286 has a sufficient length for receiving the laterally projecting portion 276 therethrough.

In one embodiment, the first retention groove 284 is formed generally in a T-shape for receiving and securing the locking member 274; however, as would be understood by those skilled in the art, the first retention groove 284 can be formed of various shapes sufficient to interlock the locking member 274 in the first retention groove 284 sufficient to secure it therein and conduct electricity. In one example, the first retention groove 284 includes only a second channel portion 288 and no first channel portion 286; thus, the first retention groove 284 has a generally slot type of shape. In another embodiment, the female interlock 280 includes only a second channel portion 288 as a slot or channel shape.

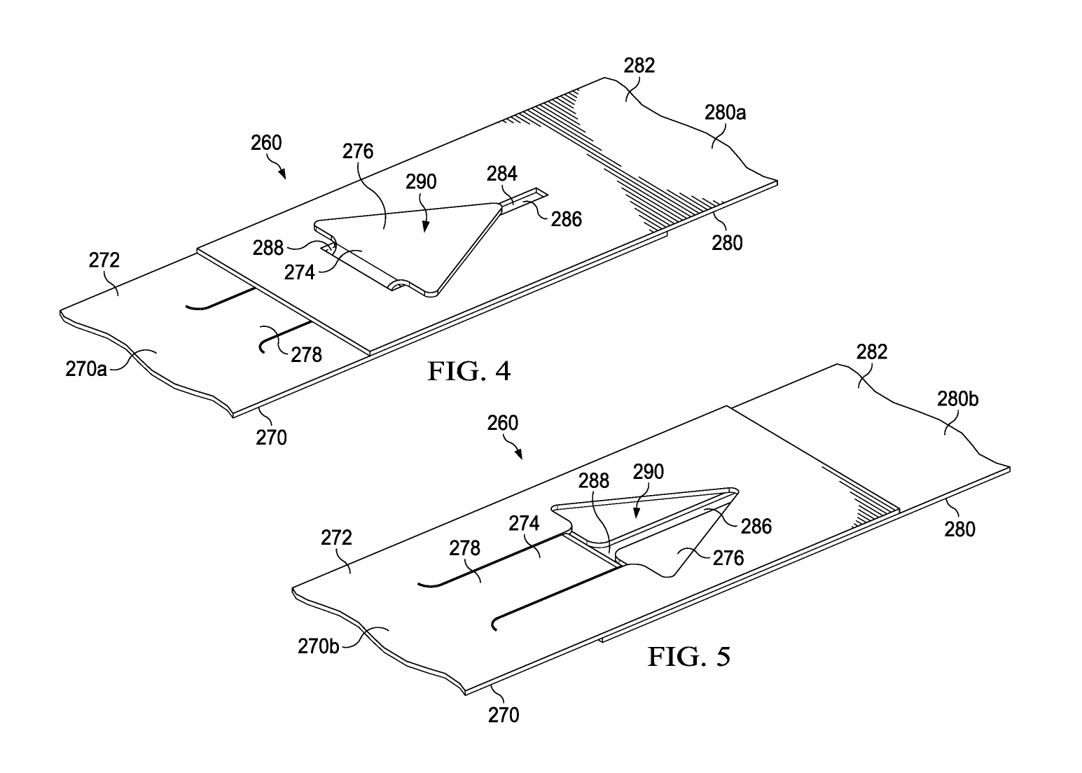

The first extended portion 278 of the locking member is adapted to be deflected slight upward or downward so as to be slidably received or inserted in the first retention groove 284. In one embodiment, the laterally projecting portion 276 is adapted to be deflected slightly inward to be slidably received through the first retention groove 284. The laterally projecting portion 276 of the locking member 270 extends beyond the second channel portion 288 so the laterally projecting portion 276 cannot slide back through the second channel portion 288 without manual adjustment. In one embodiment, as shown in FIG. 4, the laterally projecting portion 276 of the locking member 270 extends longitudinally and does not extend beyond the first channel portion 286.

The locking member 274 is then positioned on a surface of the female interlock 280 to be in flush contact therewith. In one embodiment, the locking member 274 is positioned on a top surface 280a of the female interlock 280. The top surface 270a of the male interlock 270 parallel to the top surface 280a of the female interlock 280. In this locked position, a portion of the bottom surface 280b of the female interlock 280 is in contact or overlaps a top portion 270a of the male interlock 270 in an amount sufficient to conduct electricity. The overlapping surfaces of the female and male interlocks 280 and 270 along with the retained locking member 274 in the first retention groove 284 positioned on a surface of the female interlock 280 provide a sufficient amount of overlapping and contacting surfaces to conduct electricity from the male interlock 270 to the female interlock 280 and to the ice protection system 140.

In one embodiment, the overlapping surfaces of the male and female interlocks 270 and 280 extend over from about 30% to about 70% of the length of each interlock from end to end along the longitudinal axis C. In one embodiment, the overlapping surfaces of the male and female interlocks 270 and 280 extend over from about 40% to about 60% of the length of each interlock from end to end along the longitudinal axis C.

An embodiment provides that the overlapping surfaces of the female and male interlocks 280 and 270 along with the retained locking member 274 in the first retention groove 284 positioned on a surface of the female interlock 280 remain in contact even when subjected to bending and rotational forces during operation of the aircraft.

In another embodiment, a portion of the top surface 270a of the male interlock 270 is in contact with or overlaps a top portion 280a of the female interlock 280 in an amount sufficient to conduct electricity. In this embodiment, shown in FIG. 4, the female interlock 280 is positioned below the male interlock 270.

In one embodiment, the male interlock 270 and female interlock 280 are each made of a conductive material for example, but not limitation, beryllium copper. An embodiment provides a method of imprinting or etching a sheet of beryllium copper with a pattern of the interplanar locking features, as shown in FIG. 3, of the male and female interlocks 270 and 280.

In an embodiment, a male or female interlock of the electrical interconnect 160 is integrally formed with the bus bar or a heating zone. In one embodiment, the bus bar 142a can integrally include a male interlock 270 portion of the electrical interconnect 160f, which the male interlock 270 is etched into an end of the bus bar 142a as shown in FIG. 2A. The female interlock 280 of the electrical interconnect 160f is disposed at an end of the heating zone 150a and is integral to the heating zone 150a and oriented in a manner sufficient to be secured with the male interlock 270 portion of the electrical interconnect 160f in the bus bar 142a. As shown in FIG. 2A, the electrical interconnect 160f is adjacent to the leading edge of the rotor blade 136.

The bus bar 142b can integrally include a female interlock 280 portion of the electrical interconnect 160j, which is etched into an end of the bus bar 142b as shown in FIG. 2A. The male interlock 270 of the electrical interconnect 160j is disposed at an end of the heating zone 150a and is integral to the heating zone 150a and oriented in a manner sufficient to be secured with the female interlock 280 portion of electrical interconnection 160j in the bus bar 142b. As shown in FIG. 2A, the electrical interconnect 160j is adjacent to the trailing edge of the rotor blade 136.

In another embodiment, the male interlock 270 and the female interlock 280 can each have a thickness of about 0.002 inches to about 0.030 inches. The thickness of the male and female interlocks can be varied depending on the electrical requirements of the system and the packaging requirements of the rotor blade 136 or other type of parent structure. An embodiment provides, that the connected male interlock 270 and the female interlock 280 can have a thickness of about 0.004 to about 0.090 in a first locked position 290.

In still another embodiment, an electrically conductive adhesive is positioned between overlapping portions of the male interlock 270 and female interlock 280. In an embodiment, the male and female interlocks 270 and 280 are pre-tinned or soldered at the locking and/or overlapping portions to weld the male and female interlocking features together.

In an embodiment, the male interlock 270 and female interlock 280 are configured and arranged to selectively be released from interconnection by relative rotation and deflection between the locking member 274 and the first retention groove 284.

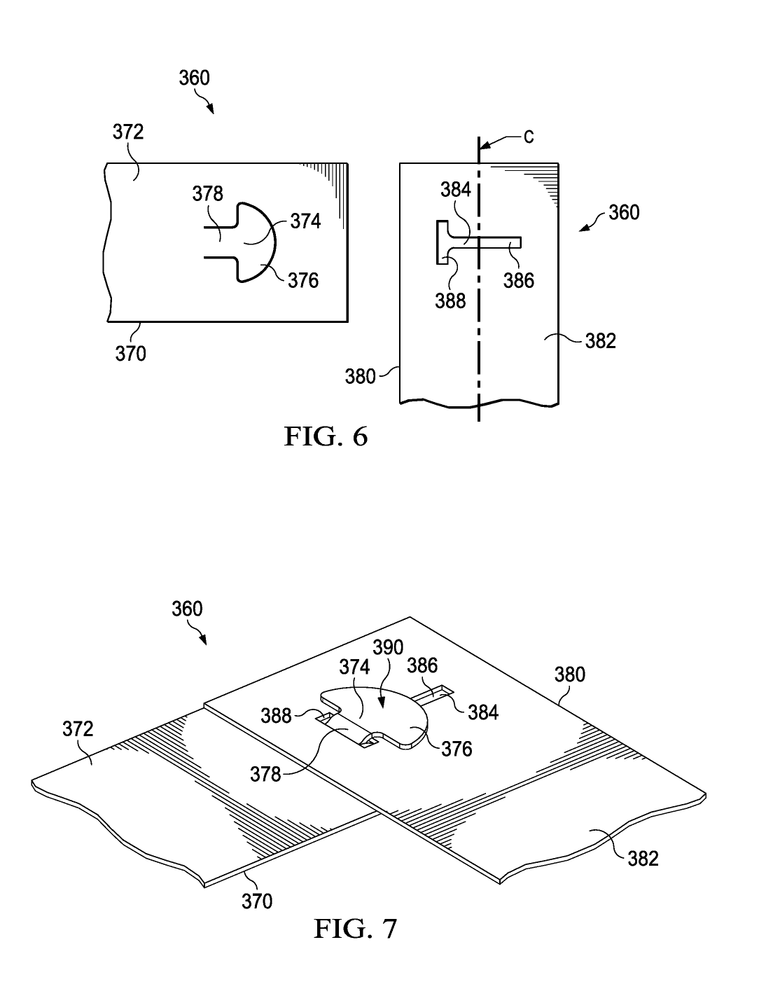

FIGS. 6-8 show an embodiment of the electrical interconnect 260. Certain features of the electrical interconnect 260 are as described above and bear similar reference characters to the electrical interconnect 260, but with a leading ‘3’ rather than a leading ‘2’. The locking member 374 includes a laterally projecting portion 376 that is generally a semi-circular shape, which extends beyond the second channel portion 388 when in a first locked position 390. In this embodiment, the first channel 386 is disposed at a 90 degrees angle relative to the longitudinal axis C of the female interlock 380, as shown in FIG. 6.

FIGS. 9-13 show an embodiment of the electrical interconnect 260. Certain features of the electrical interconnect 260 are as described above and bear similar reference characters to the electrical interconnect 260, but with a leading ‘4’ rather than a leading ‘2’. The locking member 474 that extends beyond the base portion 472. The locking member 474 includes a laterally projecting portion 476 is generally rectangular in shape with a pair of tabs on the sides of locking member 474.

In an embodiment, the laterally projecting portion 476 of the locking member 470 extends beyond the second channel portion 488 so the laterally projecting portion 476 cannot slide back through the second channel portion 488 without manual adjustment. In one embodiment, the laterally projecting portion 476 extends longitudinally beyond the first channel portion 486 and forms a second extended portion 475 of the locking member 470.

In one embodiment, the female interlock 480 includes a second retention groove 485 generally parallel to the second channel portion 488 and disposed on a distal end of the support member 482, the second retention groove 485 being dimensioned to permit insertion of the second extended portion 475 therethrough. In an embodiment, the second retention groove 485 is a slot shape. The second retention groove 485 has a sufficient width to receive at least a portion of the second extended portion 475 of locking member 470.

The second extended portion 475 of the locking member 470 is adapted to be deflected slight upward or downward so as to be slidably received or inserted in the second retention groove 485 to form a second locked position 491. The second extended portion 475 is then positioned on a surface of the female interlock 480 to be in flush contact therewith. As shown in FIG. 11, the top surface 475a of second extended portion is in flush contact with the bottom surface 480b of the female interlock 480.

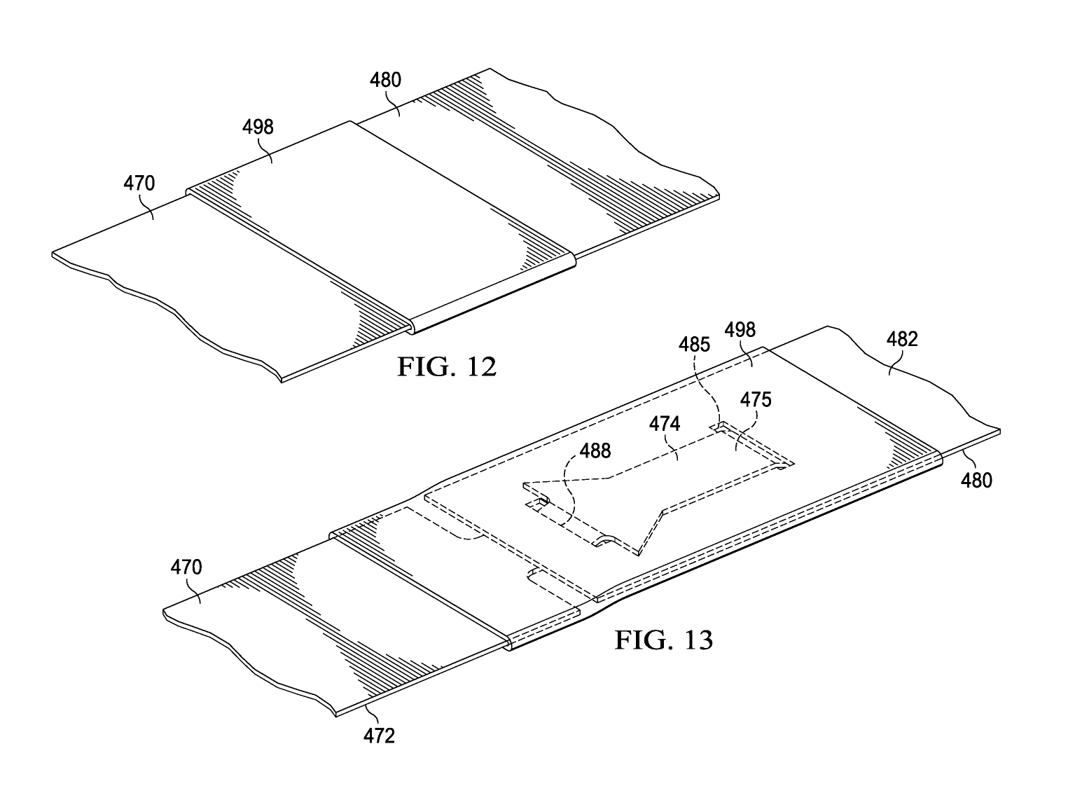

In another embodiment, shown in FIGS. 12-13, the electrical interconnect 460 includes a sleeve 498 which encompasses at least a portion of the male interlock and the female interlock when in the first locked position. In one embodiment, the sleeve 498 or is positioned around the interlocked male interlock 470 and female interlock 480 to provide pressure, insulation, or protection from intrusion of other materials into the mechanical interconnect 460. The sleeve 498 can be made from rubber, plastic, electrical insulation material, electrical tap, or another material sufficient to surround the locked portion of the electrical interconnect.

An embodiment provides a composite assembly 501 that can be used for an aircraft component such as for a rotor blade 136 and a schematic portion of the composite assembly 501 is shown in FIG. 2B. Certain features of the rotor blade 136 and electrical interconnect 160 are as described above and bear similar reference characters to the rotor blade 136 and electrical interconnect 160, but with a leading ‘5’ rather than a leading ‘2’. The composite assembly 501 can include an outer surface member 536a, an inner surface member 536b, and an electrical interconnect 560 including a male interlock 570 and a female interlock 580. The electrical interconnect 560 can be sandwiched between the outer surface member 536a and inner surface member 536b disposed on the inner surface 536b. Once the electrical interconnect 560 is positioned between the outer and inner surface members 536a and 536b, respectively, a constant pressure can be applied to the male and female interlocks 570 and 580, which further supports and retains flush contact between the male and female interlocks 570 and 580. The particular thickness, size, and angle of orientation of the male and female interlocks 570 and 580 within the composite assembly can vary depending on the location, profile of the surface member, and the type of electrically powered component. In one embodiment, the inner surface member 536b is an uncured surface.

In one embodiment, the outer surface member 536a is a surface located at some depth below an outer surface of the rotor blade 536 and is disposed above the inner surface member 536b. In another embodiment, the outer surface member 536a is an outer skin for a rotor blade 536.

In yet another embodiment, the outer surface member 536a is a heating zone disposed below an outer skin surface of the rotor blade 536. In one embodiment, the outer surface member 536a is a heating zone disposed about 0.025 inches below the outer skin surface of the rotor blade 536. The electrical interconnect 560 is positioned between the heating zone outer surface member 536a and above the inner surface member 536b such that the electrical interconnect 560 is sandwiched between the layers 536a and 536b, which provides insulation and pressure for the electrical interconnect 560.

An embodiment provides a method of constructing a composite assembly including providing an outer surface member 536a, providing an inner surface member 536b, and positioning an electrical interconnect 560 on the inner surface member. A further step can include applying electrically conductive adhesive the electrical interconnects 560 male interlock 570 and female interlock 580. Another step can include applying an electrically conductive adhesive between the locking member 574 and the female interlock 580. One step includes applying solder to secure the male interlock 570 and female interlock 580 in a first locked position. Another embodiment provides curing at least one of the outer surface member 536a and the inner surface member 536b so as to impart compressive force against the electrical interconnect 560.

The illustrative embodiments of the electrical interconnected described herein advantageously provide a mechanical interconnect that can be applied to an area where electrical power is needed in a space constrained location. Moreover, an embodiment provides that the electrical interconnect can be used on a flexible body and can directly withstand the strain levels caused by movement of the flexible body and remain in a locked and electrically conductive position.

At least one embodiment is disclosed and variations, combinations, and/or modifications of the embodiment(s) and/or features of the embodiment(s) made by a person having ordinary skill in the art is within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes 2, 3, 4, etc.; greater than 0.10 includes 0.11, 0.12, 0.13, etc.). For example, whenever a numerical range with a lower limit, Rₗ, and an upper, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Unless otherwise stated, the term “about” shall mean plus or minus 5 percent of the subsequent value. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrow terms such as consisting of, consisting essentially of, and comprised substantially of. Accordingly, the scope of protection is not limited by the description set out above but is defined by the claims that follow, the scope including all equivalents of the subject matter of the claims. Each and every claim is incorporated as further disclosure into the specification and the claims are embodiment(s) of the present invention.

1. An electrical interconnect comprising:
an electrically conductive male interlock having a substantially flat base portion and a longitudinally extending locking member, the base portion surrounds the locking member in an unlocked position; and
an electrically conductive female interlock having a first retention groove in a support member, the first retention groove for receiving and retaining the locking member on the support member;
wherein at least a portion of the locking member is disposed on a surface of the female interlock and slidably received in the first retention groove in a first locked position so as to enable electrical conduction.

2. The electrical interconnect of claim 1, wherein the locking member has sufficient flexibility to accommodate bending to the first locked position.

3. The electrical interconnect of claim 1, wherein the longitudinally extending locking member has a laterally projecting portion that extends beyond the first retention groove.

4. The electrical interconnect of claim 3, wherein the laterally projecting portion has sections adapted to be deflected in an inward direction to secure into the first locked position.

5. (canceled)

6. The electrical interconnect of claim 1, wherein the laterally projecting portion is generally triangular in shape.

7-8. (canceled)

9. The electrical interconnect of claim 1, wherein the laterally projecting portion is a pair of tabs on the sides of locking member.

10. (canceled)

11. The electrical interconnect of claim 1, wherein the first retention groove has a first channel portion extending along a longitudinal axis in the support member and a second channel portion extending transverse to the longitudinal axis being dimensioned to permit insertion of the locking member therethrough.

12. The electrical interconnect of claim 11, wherein the first channel portion has an angle of about zero to about 90 degrees relative to the longitudinal axis of the support member.

13. The electrical interconnect of claim 11, wherein the locking member does not extend beyond the first channel portion.

14-20. (canceled)

21. The electrical interconnect of claim 1, wherein the support member surrounds the first retention member in an unlocked position.

22. The electrical interconnect of claim 1, wherein the base portion is generally rectangular in shape.

23. The electrical interconnect of claim 1, wherein the support member is generally rectangular in shape.

24. An electrical interconnect comprising:
an electrically conductive male interlock having a substantially flat base portion and a longitudinally extending locking member; and
an electrically conductive female interlock having a first retention groove in a support member, the first retention groove for receiving and retaining the locking member on the support member, the support member surrounds the first retention groove in an unlocked position,
wherein at least a portion of the locking member is disposed on a surface of the female interlock and slidably received in the first retention groove in a first locked position so as to enable electrical conduction.

25. The electrical interconnect of claim 24, wherein the locking member has sufficient flexibility to accommodate bending to the first locked position.

26. The electrical interconnect of claim 24, wherein the longitudinally extending locking member has a laterally projecting portion that extends beyond the first retention groove.

27. The electrical interconnect of claim 26, wherein the laterally projecting portion has sections adapted to be deflected in an inward direction to secure into the first locked position.

28. The electrical interconnect of claim 24, wherein the base portion is generally rectangular in shape.

29. The electrical interconnect of claim 24, wherein the support member is generally rectangular in shape.
